(19) United States
(12) Patent Application Publication
(10) Pub. No.: US 2008/0289651 A1
(43) Pub. Date: Nov. 27, 2008

(54) METHOD AND APPARATUS FOR WAFER EDGE CLEANING

(75) Inventors: Kangguo Cheng, Beacon, NY (US); Louis C. Hsu, Fishkill, NY (US); Jack A. Mandelman, Flat Rock, NC (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/753,711

(22) Filed: May 25, 2007

(51) Int. Cl. B08B 6/00

(52) U.S. Cl. 134/1.3; 134/105

(57) ABSTRACT

A wafer edge cleaning system that includes a wafer dry etching chamber and one or more irradiation sources preferably positioned inside the wafer dry etching chamber. The irradiation source such as laser generates a beam aimed at the periphery of the wafer to melt any defects, in particular, black silicon at the edge of the wafer. Preferably, the wafer is mounted on a rotating platform. The invention further provides a method for removing black silicon at the edge of a semiconductor wafer that includes the steps of: patterning the wafer with a trench mask layer; etching the wafer to form a trench thereon; exposing the edge of the wafer to a laser beam to melt the black silicon thereon; stripping the mask and cleaning the wafer.

### BACKGROUND OF THE INVENTION

1. Field of the Invention

The present invention relates generally to the field of semiconductor wafer fabrication, and more particularly to a method and a system for removing defects at the edges of a wafer without the need for sacrificial materials and/or patterning.

2. Description of the Prior Art

In the process of fabricating semiconductor devices, defects are inevitably generated. For example, in the process of etching deep trenches in a silicon wafer, a set of silicon spikes 40, referred to as “black silicon”, are formed at the wafer edge as shown in FIG. 1. The name “black silicon” comes from the property that visible light is absorbed by regions containing a high density set of spikes. Black silicon refers to spikes usually about 4 to 8 micrometers in height. These unwanted needle type structures form because dielectrics are left on the surface of the wafer, typically after etching. While some of the dielectric protects the underlying silicon from being etched away, unprotected portions of the wafer remain exposed, continuing to be etched. As a result, needle type structures are formed at protected portions of the silicon substrate during reactive-ion-etch. This black silicon may be knocked off in subsequent processes, and pulverized into small particles. During subsequent processing the surface of the wafer is contaminated by the small particles freed from the black silicon, resulting in severe defects and yield loss.

Still referring to FIG. 1, deep trenches 30 are formed in a semiconductor wafer 10 by deposition of mask layers such as pad oxide 20, pad nitride and oxide hardmask 15, followed by a conventional patterning method such as lithography and reactive-ion-etching (RIE). Black silicon 40 is undesirably formed at wafer edge 10E due to severe erosion of the hardmask. It is known that the edges of the wafer cannot be controllably and uniformly coated with photo-resist, resulting in regions at the edge of the wafer wherein the pad and the hard mask are eroded away during reactive ion etching. During trench etching, the mask material from adjacent areas is sputtered and deposited on the edge of the wafer which forms a “micro-mask”, that results in the formation of very dense silicon spikes. The black silicon spikes are formed at the peripheral area of the wafer, and if not removed immediately, could cause wafer contamination and jeopardize yield.

Various techniques have been proposed to prevent the formation and/or removal of black silicon, with varying degrees of success. These techniques are described, for instance, in U.S. Pat. Nos. 6,033,997; 6,291,315; and 6,806,200, which provide methods for preventing the formation of black silicon by forming a sacrificial layer at the wafer edge before etching deep trenches. This sacrificial layer protects the wafer edge in the process of etching deep trenches. The methods advanced require additional process steps such as film deposition and patterning, which add to the complexity and cost, and further, they are the cause for other defects.

U.S. Pat. Nos. 6,383,936 and 6,750,147 teach methods of removing the black silicon at the wafer edge while protecting other regions with sacrificial material. These methods require additional process steps such as deposition, patterning, and removal of the sacrificial material, all of which add to the process complexity and cost, and are the cause of other defect issues.

U.S. Pat. No. 6,713,236 describes a method to prevent the formation of black silicon by treating the resist at wafer edge with a solution such that, a priori, no trench patterning is formed at the edges of the wafer. Although this method may reduce the chance of black silicon formation, it does not completely prevent it. In addition, the non-standard process to prevent trench patterning at wafer edge may also lead to other process control issues.

### OBJECTS AND SUMMARY OF THE INVENTION

Thus, it is an object of the invention to provide an apparatus and a method for removing defects at the wafer edge without requiring any sacrificial material and patterning.

It is another object of the invention to remove black silicon on a semiconductor wafer while minimally impacting the formation of other severe defects leading to yield loss.

To achieve these and other objects, aspects and advantages of the invention, the wafer edge is exposed to an irradiation beam, such as a laser beam, after forming deep trenches. The irradiation energy is absorbed by the defects which are heated to a temperature such that the defects melt and are subsequently easily removed. The property that black silicon is an effective absorber of visible and near visible light is used advantageously to produce selective heating and melting. By contrast, a large fraction of the laser energy is reflected from the wafer surface adjacent to black silicon regions. Thus, selective heating, melting and removal of the black silicon without the need for masking is achieved.

In one aspect of the invention, there is provided a wafer edge cleaning system that includes a wafer dry etching chamber and one or more irradiation sources preferably positioned inside the wafer dry etching chamber, with the irradiation source generating a beam aimed at a periphery of the wafer to melt any defects, in particular, black silicon at the edge of the wafer. Preferably, the wafer is mounted on a rotation platform while the irradiation source remains stationary with respect of the wafer.

The irradiation source is selected from a group consisting of various types of laser beams. Although laser sources producing radiation within the visible or near visible spectrum are preferred, a wide range of wavelengths such as deep-IR, IR, UV, extreme UV and x-rays may also be useful, and are contemplated. ArF, KrF, XeCl, XeF, and F₂ excimer lasers are preferred. Laser sources such as CO₂, Nd:YAG, CO may also be employed. Frequency doubling may be used where appropriate to improve selective absorption of radiation incident upon black silicon.

In another aspect of the invention, there is provided a method for providing in-situ wafer edge annealing to clean a wafer edge that includes the steps of: post dry etching a wafer; aiming a laser beam at the edges of the etched wafer, to remove by melting, black silicon or other defects that may exist at the edges of the etched wafer.

The laser beam is preferably mounted on a rotating platform that uniformly that scans the etched wafer periphery, generating heat at selected areas thereof, and removing post-etch black-silicon. The etched wafer is preferably mounted on a rotating platform inside of a wafer dry etching chamber having said laser beam rigidly mounted thereon, or vice versa, the laser beam and wafer may uniformly rotate with respect to one another in opposite directions.

### BRIEF DESCRIPTION OF THE DRAWINGS

The accompanying drawings, which are incorporated in and which constitute part of the specification, illustrate the presently preferred embodiments of the invention which, together with the general description given above and the detailed description of the preferred embodiment given below serve to explain the principles of the invention.

FIG. 1 illustrates black silicon formed at wafer edge after deep trench etch.

FIGS. 2 illustrates a first example of a laser attached to a chuck to remove the black silicon.

FIG. 3 shows a second example of a rotating scanning ring mechanism to physically remove the black silicon.

FIG. 4 is a flow chart illustrating of the process steps to remove defects at wafer edge, according to this invention.

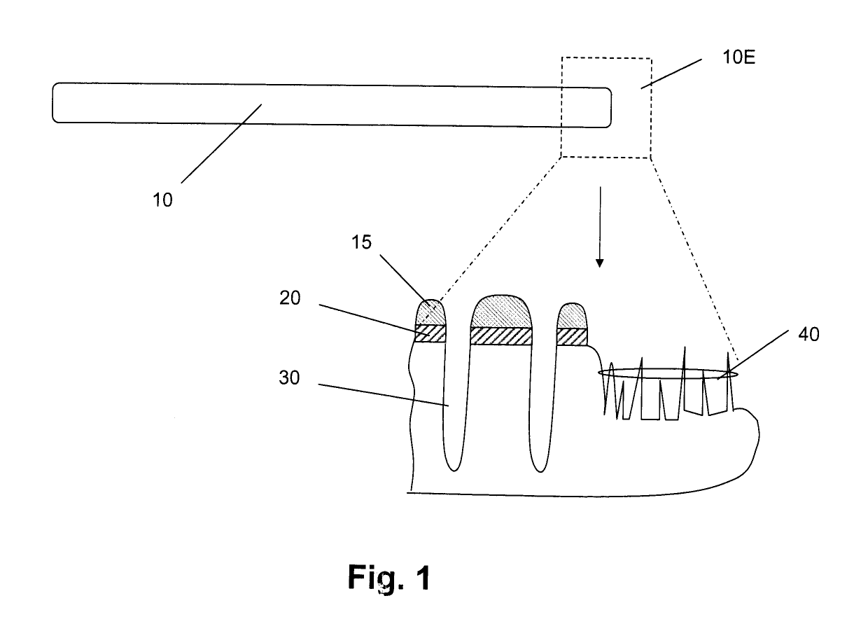

### DETAILED DESCRIPTION OF A PREFERRED EMBODIMENT

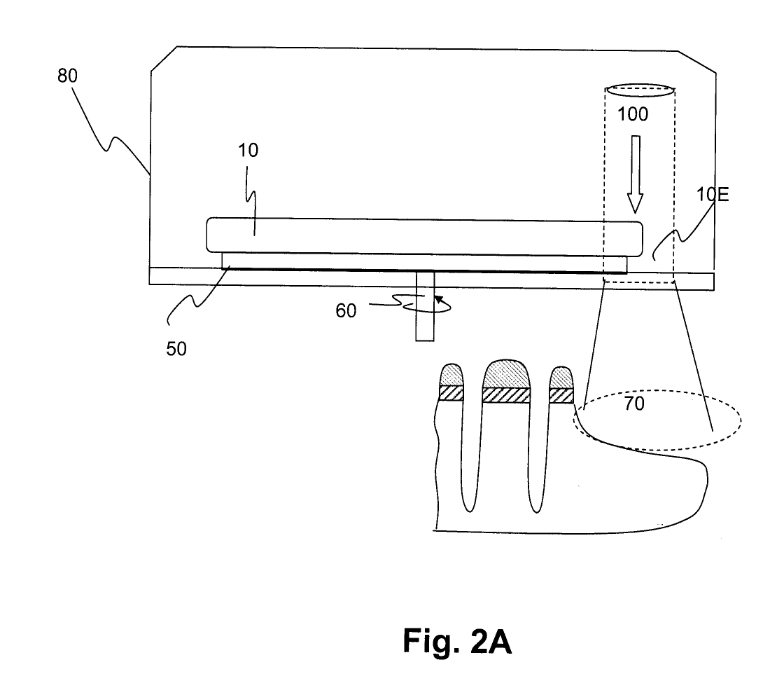

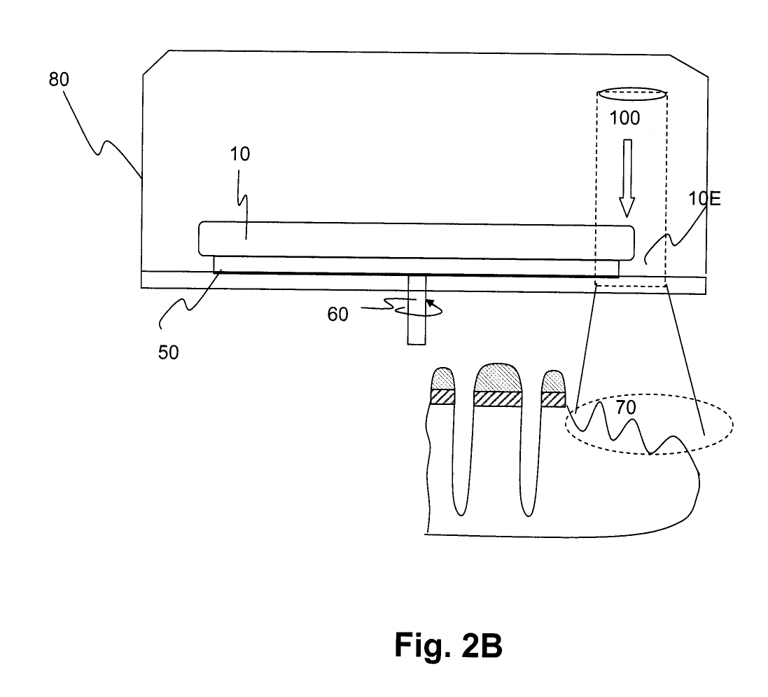

Referring to FIG. 2, a post-etch wafer 10 is positioned on wafer holder 50 having a spinning post 60. The wafer edge 10E is exposed to a laser beam 100. The wafer is spun at a predetermined rate. The rate of rotation of the wafer may range from about 1 to about 3600 rpm, with 10 to 10 rpm preferred.. Black silicon, which typically becomes amorphous due to ion bombardment during the RIE process, has a lower melting point than single-crystal silicon. It absorbs the light energy and melts, resulting in a smooth profile at the wafer edge. The rough surface which is filled with high-density of spiking structures enhances the light absorption, and results in a rapid meltdown of the back-silicon.

The preferred source of irradiation is a laser beam. The laser beam can advantageously operate in a continuous wave (CW) or pulsed mode. The wavelength of the laser preferably ranges from 0.1 μm to 20 μm. A XeCl excimer laser having a wavelength of 308 nm is preferably used to melt the black silicon. Alternatively, KrF (248 nm), ArF (193 nm), or F₂ (157 nm) excimer lasers can be used. The pulse duration of the laser preferably ranges from 1 femtoseconds to 10 milliseconds. More preferably, the pulse duration spans from 10 nanoseconds to 100 nanoseconds. The laser can be focused to various shapes such as a circle, a square, or a rectangle. For a laser focused to a circle shape, the beam size varies with a diameter in a range from 0.01 mm to 10 mm. Preferably, the beam size ranges from 1 mm to 3 mm. Frequency doubling of the laser energy may also be used to optimize radiation absorption selectivity between black silicon and adjacent areas.

The laser fluence can be in a range of 0.01-10 J/cm², and is advantageously set to a value such that sufficient heat is generated to melt the black silicon. For example, a fluence of 0.5-2 J/cm² can be used for the meltdown.

The wafer is preferably placed on a chuck when black silicon at the wafer periphery is exposed to a laser beam. In one embodiment, the laser beam is fixed and the wafer is rotated along with the chuck. In another embodiment, the wafer is fixed and the laser beam is rotated to scan wafer the wafer periphery. In a third embodiment, the wafer and the laser beam are rotated in opposite directions.

In yet another embodiment, the laser beam is integrated into the deep trench etch system. The wafer periphery is exposed to the laser beam in the same chamber after deep trench etch. In still another alternate embodiment, the laser cleaning system is a standalone system. In yet another embodiment, the laser cleaning system and the deep trench etch system are on the same platform.

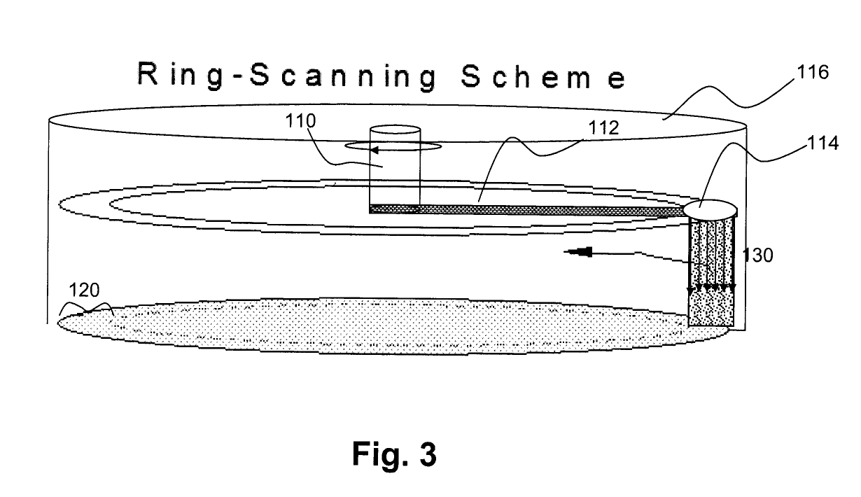

Referring to FIG. 3, a ring scanning scheme 110 can be used to melt black silicon at the wafer 120 edge. The scheme can be readily integrated into existing laser anneal systems having a laser beam source 130 mounted at the upper location of an etching reactor.

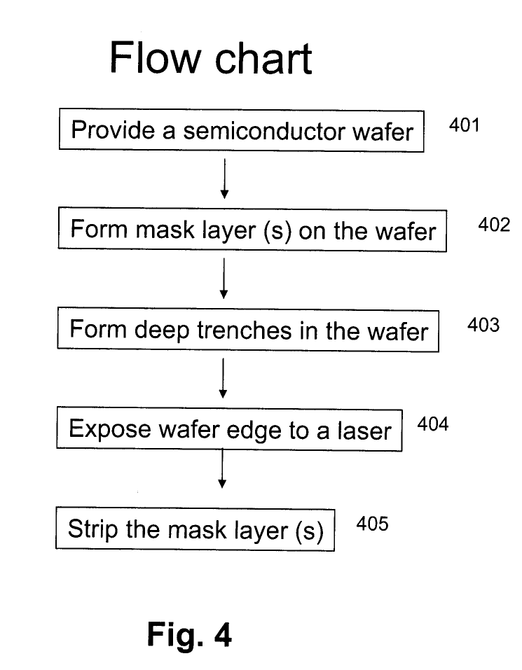

FIG. 4 shows a flow chart according to the present invention. A semiconductor wafer 401 is patterned with a (trench) mask layer 402. Next, the wafer is etched to form a trench on the wafer 403. Finally, the periphery of the wafer is exposed to a laser beam 404 to remove the black silicon. The mask is then stripped, followed by cleaning the wafer 405.

While the invention was described by means of a simple illustrative example, it is to be understood that one of ordinary skill in the art can extend and apply this invention in many obvious ways. It should be understood, however, that the description, while indicating preferred embodiments of the present invention and numerous specific details thereof, is given by way of illustration and not of limitation. Many changes and modifications may be made within the scope of the present invention without departing from the spirit thereof, and the invention includes all such modifications.

What is claimed is:

1. A wafer edge cleaning system comprising:
a wafer dry etching chamber; and
at least one irradiation source coupled to said wafer dry etching chamber, said irradiation source generating a beam which is aimed at the wafer's periphery, melting defects thereat.

2. The wafer edge cleaning system as recited in claim 1, wherein said wafer is mounted on a rotation platform.

3. The wafer edge cleaning system as recited in claim 1, wherein said at least one irradiation source is a laser beam.

4. The wafer edge cleaning system as recited in claim 3, wherein said laser beam operates in a continuous wave or a pulsed mode.

5. The wafer edge cleaning system as recited in claim 3, wherein said laser beam has a wavelength ranging between 0.1 μm and 20 μm.

6. The wafer edge cleaning system as recited in claim 3 wherein said laser beam is generated by an XeCl excimer laser having a wavelength of 308 nm.

7. The wafer edge cleaning system as recited in claim 3, wherein said excimer laser is selected from a group consisting of KrF, ArF, and F₂, with respective wavelengths equal to 248 nm, 193 nm, and 157 nm.

8. The wafer edge cleaning system as recited in claim 3, wherein said laser beam has a pulse duration ranging from 1 femtoseconds to 10 milliseconds.

9. The wafer edge cleaning system as recited in claim 3, wherein said laser beam has a pulse duration ranging from 10 nanoseconds to 100 nanoseconds.

10. The wafer edge cleaning system as recited in claim 3, wherein said laser generates shapes selected from a group consisting of a circle, a square, and a rectangle.

11. The wafer edge cleaning system as recited in claim 9, wherein said laser beam generating a circular shape has a beam size with a diameter ranging between 0.01 mm to 10 mm.

12. The wafer edge cleaning system as recited in claim 3, wherein said laser beam generates shapes having a size ranging from 1 mm to 3 mm.

13. The wafer edge cleaning system as recited in claim 3, wherein said laser has a fluence ranging from 0.01 to 10 J/cm².

14. The wafer edge cleaning system as recited in claim 13 wherein said laser beam has a fluence of 0.5-2 J/cm² that generates heat sufficient to melt black silicon.

15. A method of providing in-situ wafer edge annealing to clean a wafer edge comprising the steps of:
a) post dry etching a wafer;
b) aiming a laser beam at edges of said etched wafer; and
c) melting black silicon at the edges of said etched wafer.

16. The method as recited in claim 15, wherein said laser beam is mounted on a rotating platform that uniformly scan said etched wafer periphery.

17. The method as recited in claim 16, wherein said laser beam generates heat that removes post-etch black-silicon at said wafer periphery.

18. The method as recited in claim 15, wherein said etched wafer is mounted on a rotating platform coupled to a wafer dry etching chamber having said laser beam rigidly mounted thereon.

19. The method as recited in claim 15, wherein said laser beam and said wafer uniformly rotate in opposite directions with respect to one another.

20. The method for removing black silicon at an edge of a semiconductor wafer comprising the steps of:
patterning the wafer with a trench mask layer;
etching the wafer to form a trench thereon;
exposing the edge of the wafer to a laser beam to melt the black silicon thereon; and
stripping the mask and cleaning the wafer.
